(19) United States
(12) Patent Application Publication
(10) Pub. No.: US 2011/0033374 A1
(43) Pub. Date: Feb. 10, 2011

(54) CATALYSED FILTER

(75) Inventor: David William Prest, Durham (GB)

Correspondence Address: RatnerPrestia (JM), P.O. Box 980, Valley Forge, PA, 19482-0980, US

(73) Assignee: JOHNSON MATTHEY PUBLIC LIMITED COMPANY, London (GB)

(21) Appl. No.: 12/864,347

(22) PCT Filed: Jan. 21, 2009
(86) PCT No.: PCT/GB2009/050049

§ 371 Date: Oct. 18, 2010

(30) Foreign Application Priority Data
Jan. 23, 2008 (GB) 0801161.1

(51) Int. Cl. B01D 53/94; C01B 39/00; C01F 7/02; B01J 21/04; B01J 21/06; B01J 29/04; B01D 53/56

(52) U.S. Cl. 423/700; 423/625; 502/355; 502/350; 502/309; 502/60; 423/213.2; 502/100

(57) ABSTRACT

A wall-flow filter monolith substrate having a porosity of at least 40% formed from a selective catalytic reduction (SCR) catalyst of extruded type.

The present invention relates to a wall-flow filter monolith substrate comprising a catalyst and in particular a selective catalytic reduction (SCR) catalyst.

A wall-flow filter generally comprises a plurality of channels in honeycomb arrangement, typically formed from a ceramic material such as cordierite or silicon carbide, wherein at least some of the channels are plugged at an upstream end and at least some of the channels not plugged at the upstream end are plugged at a downstream end, the arrangement being such that, when viewed from one end, the arrangement of plugged and open channel ends appears like a chequer board.

As referred to herein, the term “selective catalytic reduction” (or “SCR”) refers to methods of converting nitrogen oxides in the presence of a suitable reducing agent.

In SCR by hydrocarbons (HC), HC react with NOₓ, rather than with O₂, to form nitrogen, CO₂ and water according to equation (1):

{HC}+NOₓ→N₂+CO₂+H₂O (1)

The competitive, non-selective reaction with oxygen is given by Equation (2):

{HC}+O₂→CO₂+H₂O (2)

Alternatively, a nitrogenous reductant, such as ammonia, can be used selectively to reduce NOₓ, according to reactions (3), (4) and/or (5):

4NH₃+4NO+O₂→4N₂+6H₂O (3)

2NH₃+NO+NO₂→2N₂+3H₂O (4)

8NH₃+6NO₂→7N₂+12H₂O (5)

Reaction (4) may be advantageous for certain SCR catalysts e.g. vanadia-based SCR catalyst systems (such as V₂O₅/WO₃/TiO₂) as it is relatively faster than either reactions (3) or (5).

HC-SCR catalysts are also sometimes referred to as “lean NOx catalysts” (LNCs) or “DeNOx catalysts” and even “non-selective catalytic reduction catalysts”, because NOₓ reduction using HC is a less selective reaction compared with SCR using a nitrogenous reductant. Known HC-SCR catalysts include Cu/zeolites, Pt/alumina and Ag/alumina.

SCR catalysts are available as catalyst compositions washcoated onto a substrate monolith or as components in an extrudate. With regard to the latter option, EP 0219854 discloses a catalyst for the selective reduction of nitrogen oxides to nitrogen in the presence of ammonia in the form of composite bodies formed from a mixture of anatase (5 to 40% by weight), a zeolite (50 to 90%), a bond material (0 to 30%) and, optionally, a promoter which is an oxide of vanadium, molybdenum, or copper, in the amount of at least 0.1% by weight. WO 00/30746 discloses similar catalysts.

SAE 2004-01-0075 is entitled “Durability of Extruded Homogeneous SCR Catalyst”.

EP 1300193 discloses a method and a device for the catalytic conversion of harmful substances contained in the exhaust gas of combustion engines, wherein the exhaust gas is forced to pass through a catalyst-carrying porous support. The support may be comprised of a catalytic material support itself, have a catalytic material coating its pores and/or have a catalytic layer on one or both of the surfaces through which the exhaust gas will travel.

JP 3-130522 discloses an exhaust system for treating diesel exhaust gas comprising an ammonia injector followed by a denitration catalyst-carrying ceramics porous filter.

DE 10323607 discloses a SCR catalyst combined with a particle filter in a structural unit which cannot be separated without destroying the SCR catalyst and/or particle filter.

U.S. Pat. No. 7,225,613 discloses a dual function diesel engine aftertreatment device for converting both nitrogen oxide and particulate matter.

US 2007/0259770 discloses an extruded monolithic catalytic converter and manufacturing method.

WO 01/12320 discloses a wall-flow filter for an exhaust system of a combustion engine comprising a wall-flow filter (as described hereinabove), which comprises an oxidation catalyst on a substantially gas impermeable zone at an upstream end of the channels plugged at the downstream end; and a gas permeable filter zone downstream of the oxidation catalyst for trapping soot, wherein the oxidation catalyst, which preferably includes a platinum group metal, is capable of generating sufficient NO₂ from NO to combust the trapped soot continuously at a temperature less than 400° C.

EP 1837063 discloses a method of making a honeycomb filter in which a cement is used to impermeably plug ends of channels in a extruded substrate monolith.

It is known from WO 99/39809 to combine a number of separate individual components in an exhaust system for treating, among others, particulate matter and nitrogen oxides, including a SCR catalyst. However, the number, and total volume, of exhaust gas aftertreatment components used not only increases the overall cost of the exhaust system but also increases the total volume and weight of the system. The volume available to fit a system of the sort described in WO 99/39809 may be limited. The heavier a vehicular exhaust system overall, the more fuel is required by the vehicle to transport it.

Furthermore, depending on the catalyst formulations compared and the composition of the reactant gas mixture, extruded-type SCR catalysts can be more active than washcoated SCR catalysts because there can be more catalyst per unit volume in an extruded-type SCR catalyst.

We have now developed a filter containing a SCR catalyst which combines relatively high catalyst activity with a reduction in the total volume of exhaust gas aftertreatment components in a system having similar activity for treating particulates and nitrogen oxides to known catalyst systems combining similar functionality, such as is disclosed in WO 99/39809.

According to one aspect, the invention comprises a wall-flow filter monolith substrate having a porosity of at least 40% formed from a selective catalytic reduction (SCR) catalyst of extruded type.

A wall-flow filter consists of many small parallel channels, typically of square cross-section, running axially through the part. Filter monoliths are obtained from a flow-through monoliths by plugging channels. Adjacent channels are alternatively plugged at either end so that when viewed from one end the arrangement has a chequered appearance. An aerosol, e.g. a diesel aerosol, is forced through the porous substrate walls which act as a mechanical filter. To reflect this flow pattern, the substrates are referred to as wall-flow monoliths.

It will be appreciated that “wall-flow filter” as defined herein preferably refers to an arrangement wherein a plurality of channels in honeycomb arrangement, typically formed from a ceramic material such as cordierite or silicon carbide, wherein at least some of the channels are plugged at an upstream end and at least some of the channels not plugged at the upstream end are plugged at a downstream end, the arrangement being such that, when viewed from one end, the arrangement of plugged and open channel ends appears like a chequer board. However, it also refers to alternative arrangements, wherein some of the channels are neither plugged at an upstream nor at a downstream end, which channels therefore act as a bypass to channels that provide a filtration effect. Such wall-flow filters include, for example, the arrangement disclosed in WO 00/50745.

Suitable filter monolith materials for use in the present invention have relatively low pressure drop and relatively high filtration efficiency. The skilled engineer will be aware that a trade-off exists between porosity and mechanical strength: substrates of smaller pore size and lower porosity are typically stronger than those of higher porosity. Thermal properties, both heat capacity and thermal conductivity, decrease with increasing porosity. Suitable filter materials typically have a porosity of from 45-55% or even 60% and above. A desirable feature of such materials is that they have good pore interconnectivity and as few closed or “dead end” pores as possible. Suitable mean pore diameters are from 8-25 μm, such as from 15-20 μm. The porosity values expressed herein can be measured by mercury porosimetry or electron microscopy.

In embodiments, the wall-flow filter according to the invention has a porosity of at least 45%, such as at least 50% or at least 55%.

In other embodiments, an active SCR material in an extrusion composition from which the extruded SCR catalyst is formed comprises a zeolite containing at least one transition metal. The extrusion composition can comprise alumina, which may also support at least one transition metal. The at least one transition metal in the zeolite or the alumina can be selected from the group consisting of Cu, Fe, Hf, La, Au, In, V, lanthanides and Group VIII transition metals.

In a preferred embodiment, the transition metal is cerium, iron, copper or any combination thereof.

Zeolites for use in the present invention can be natural or synthetic and include A-, X- or Y-zeolites, mordenite, beta, ZSM-5 or USY.

In a further embodiment, the active SCR material in the extrusion composition comprises titania and a vanadium oxide, which extrusion composition can also optionally contain tungsten.

In any of the above embodiments, the extrusion composition can comprise inorganic fibres to improve the mechanical strength of the filter monolith substrate.

The filter monolith substrate can be incorporated into an exhaust system for treating exhaust gases from a lean burn internal combustion engine, such as a diesel engine, particularly vehicular applications thereof. A source of reductant is generally required.

According to another aspect, the invention provides a method of making a filter monolith substrate according to any preceding claim comprising forming an extruded flow-through monolith substrate comprising a selective catalytic reduction catalyst and having an array of flow channels including first and second open channel ends, which flow-though monolith substrate having, or is capable of having, a porosity of at least 40%, inserting a plug-forming material into a plurality of first channels to form a substantially impermeable plug at the first end of the plurality of first channels and inserting the plug-forming material into a plurality of second channels to form a substantially impermeable plug at the second end of the plurality of second channels.

The plug-forming material can be a cement, for example.

According to another aspect, there is provided the use of a wall-flow filter monolith according to the invention for treating a diesel aerosol containing nitrogen oxides and particulate matter, comprising the steps of filtering diesel particulate from a carrier gas and converting nitrogen oxides in the carrier gas to nitrogen by contacting the nitrogen oxides with a reducing agent in the presence of the filter monolith. In a preferred embodiment, the invention is used for treating vehicular exhaust gases.

The reductant used can be a hydrocarbon, such as a vehicular fuel such as diesel or gasoline or an alternative HC source such as dimethyl ether (DME) or rapeseed methyl ether. Nitrogenous reductants for use in the invention include ammonia per se, hydrazine or an ammonia precursor such as urea ((NH₂)₂CO), ammonium carbonate, ammonium carbamate, ammonium hydrogen carbonate or ammonium formate.

In order to prevent emission of excess reductant to atmosphere it is possible to coat an outlet end of the filter monolith substrate with a suitable catalyst for “cleaning up” the reductant. Such catalysts are known, e.g. ammonia slip catalysts (ASC) containing relatively low loadings of platinum group metals supported on alumina or the filter material per se (see for example EP 410440).

1. A wall-flow filter monolith substrate comprising an extruded selective catalytic reduction (SCR) material, wherein the material comprises a zeolite containing at least one transition metal and wherein said substrate has a porosity of at least 40%.

2. (canceled)

3. The filter monolith substrate according to claim 1, wherein the material comprises alumina.

4. The filter monolith substrate according to claim 3, wherein the alumina supports at least one transition metal.

5. The filter monolith substrate according to claim 1, wherein the at least one transition metal is selected from the group consisting of Cu, Fe, Hf, La, Au, In, V, lanthanides and Group VIII transition metals.

6. The filter monolith substrate according to claim 1, wherein the material comprises titania and a vanadium oxide.

7. The filter monolith substrate according to claim 6, wherein the material further comprises tungsten.

8. The filter monolith substrate according to claim 1, wherein the material further comprises inorganic fibres.

9. A method for making a wall-flow filter monolith substrate comprising forming an extruded flow-through monolith substrate comprising a selective catalytic reduction catalyst and having an array of flow channels including first and second open channel ends, which flow-though monolith substrate having, or is capable of having, a porosity of at least 40%, inserting a plug-forming material into a plurality of first channels to form a substantially impermeable plug at the first end of the plurality of first channels and inserting the plug-forming material into a plurality of second channels to form a substantially impermeable plug at the second end of the plurality of second channels, wherein said inserting the plug transforms the flow-through monolith to a wall-flow monolith.

10. A method for treating a diesel engine exhaust gas containing nitrogen oxides and particulate matter, comprising the steps of filtering the particulate from the exhaust gas using a filter monolith substrate according to claim 1 and converting the nitrogen oxides in the exhaust gas to nitrogen by contacting the nitrogen oxides with the filter monolith.
